(19) United States
(12) Patent Application Publication
(10) Pub. No.: US 2004/0021676 A1
(43) Pub. Date: Feb. 5, 2004

(54) Method and apparatus of view window scrolling

(75) Inventors: Hung-Ming Chen, Taipei (TW); Ping-Hui Hsiao, Tuncheng City (TW); Lu-Yun Tai, Taoyuan (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/263,734

(22) Filed: Oct. 4, 2002

(30) Foreign Application Priority Data
Aug. 1, 2002 (TW) 91117294

(51) Int. Cl. G09G 5/00

(52) U.S. Cl. 345/684

(57) ABSTRACT

The present invention relates to a method and apparatus of view window scrolling applied in a touch-control information apparatus, the touch-control information apparatus utilizing an input device or finger of a user for an input signal. The present invention controls movement of a view window page according to a scrolling signal generated by the input device or the finger moving across a touch panel corresponding to the view window page. No characters or images are highlighted in response to the scrolling signal. After receiving the scrolling signal, the touch-control information apparatus calculates a vertical displacement and a horizontal displacement of a start coordinate value and an end coordinate value, and then moves the view window page in a vertical direction and a horizontal direction according to the calculated vertical displacement and horizontal displacement.

### BACKGROUND OF THE INVENTION

1. Field of the Invention

The present invention relates to a method of view window scrolling, and more particularly to a method and apparatus of view window scrolling, which is applied to a tablet PC, or other such intelligent devices.

2. Description of Related Art

When a user utilizes a prior art information apparatus to browse a webpage or a document, if the size of the webpage or the document is bigger than a range of a view window, the prior art information apparatus will automatically generate a scrollbar along the right side or bottom portion of the view window. These scrollbars enable a user to perform vertical and horizontal scrolling of the view window page by dragging the corresponding scrollbar.

However, for a touch-control information apparatus, such an arrangement is very inconvenient for the user. For example, touch screens, tablet PCs, and pocket PCs have no mouse or keyboard, and the user must scroll the webpage via a finger or a pen. However, the width of the scrollbar can be quite narrow, and so the user must precisely touch the scrollbar to execute the scrolling procedure. For an information apparatus with a small size screen, the size of the scrollbar will be even smaller, making it difficult for the user to scroll.

Therefore, it is desirable to provide a method and apparatus of view window scrolling to mitigate and/or obviate the aforementioned problems.

### SUMMARY OF THE INVENTION

A main objective of the present invention is to provide a method and apparatus of view window scrolling, which is able to scroll a view window page by an inputting device or a finger of a user moving on a touch panel, and thereby sufficiently increase convenience and simplify operations.

Another objective of the present invention is to provide a method and apparatus of view window scrolling, which will not cause characters or images to be highlighted when the inputting device or the finger of the user is moving across the touch panel.

Another objective of the present invention is to provide a method and apparatus of view window scrolling, which controls a moving speed and/or a moving distance of a view window page by adjusting a sensitivity of a touch-control information apparatus.

In order to achieve these objectives, the method of view window scrolling is utilized in a touch-control information apparatus. The touch-control information apparatus is used to display at least one view window page, and comprises a touch panel for inputting signals into the touch-control information apparatus via an input device or a finger of a user. The touch-control information apparatus receives a scrolling signal generated by the inputting device or the finger moving across the touch panel corresponding to a current view window. The scrolling signal stores a start coordinate value and an end coordinate value for the movement of the inputting device or the finger on the touch panel. A vertical displacement and a horizontal displacement of the start coordinate value and the end coordinate value are calculated. The view window is then scrolled in a horizontal direction according to the horizontal displacement, and scrolled in a vertical direction according to the vertical displacement.

According to another objective, the present invention provides a touch-control information apparatus for displaying at least one view window page, and comprises a touch panel for inputting signals into the touch-control information apparatus via an input device or a finger of a user in order to implement the aforesaid method.

Other objectives, advantages, and novel features of the invention will become more apparent from the following detailed description when taken in conjunction with the accompanying drawings.

### BRIEF DESCRIPTION OF THE DRAWINGS

FIG. 1 is a schematic drawing of practical environment of the present invention.

FIG. 2 is a flowchart of an embodiment of the present invention.

FIG. 3A is a movement schematic drawing of a first embodiment of the present invention.

FIG. 3B is a movement schematic drawing of a first embodiment after a sensitivity has been adjusted to a higher setting.

FIG. 3C is a movement schematic drawing of a first embodiment after a sensitivity has been adjusted to a lower setting.

FIG. 4 is a movement schematic drawing of a view window page of a second embodiment of the present invention.

### DETAILED DESCRIPTION OF THE PREFERRED EMBODIMENT

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

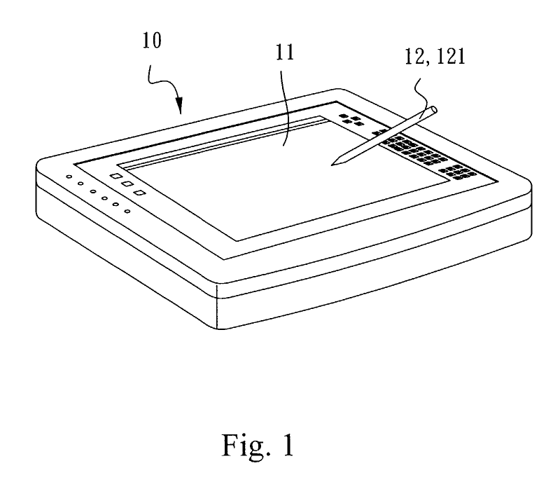

Please refer to FIG. 1. FIG. 1 is a schematic drawing of practical environment of the present invention. A tablet PC 10 comprises a touch panel 11, and utilizes an input device 12 to input signals to the touch panel 11. The input device 12 is a pen 121 (also called a handwriting pen or a touch-control pen). Of course the tablet PC 10 can also accept input signals via a finger of a user. Furthermore, this embodiment not only can be applied to the tablet PC 10, but may also be utilized in other equivalent touch-control information devices, such as a personal digital assistant (PDA), a pocket (palm top) PC, and etc.

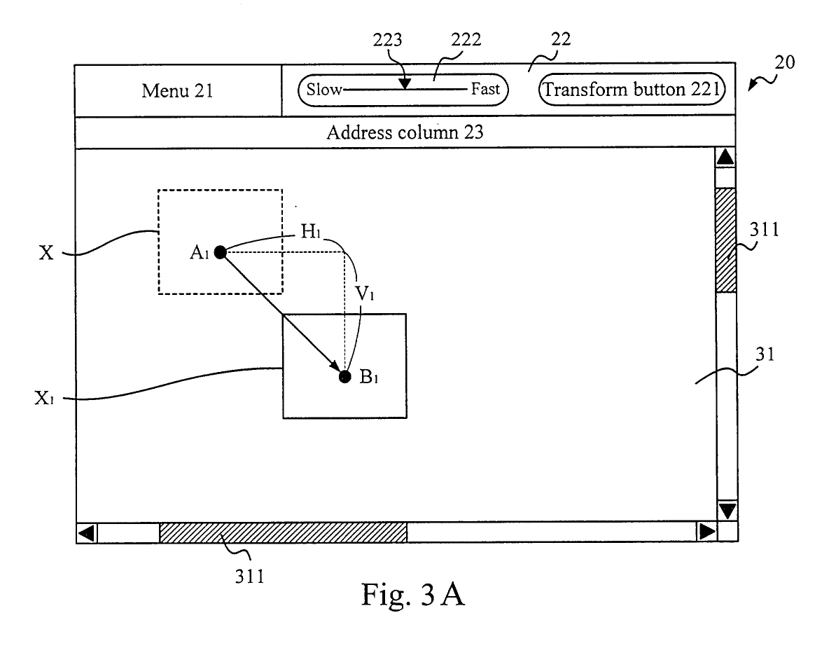

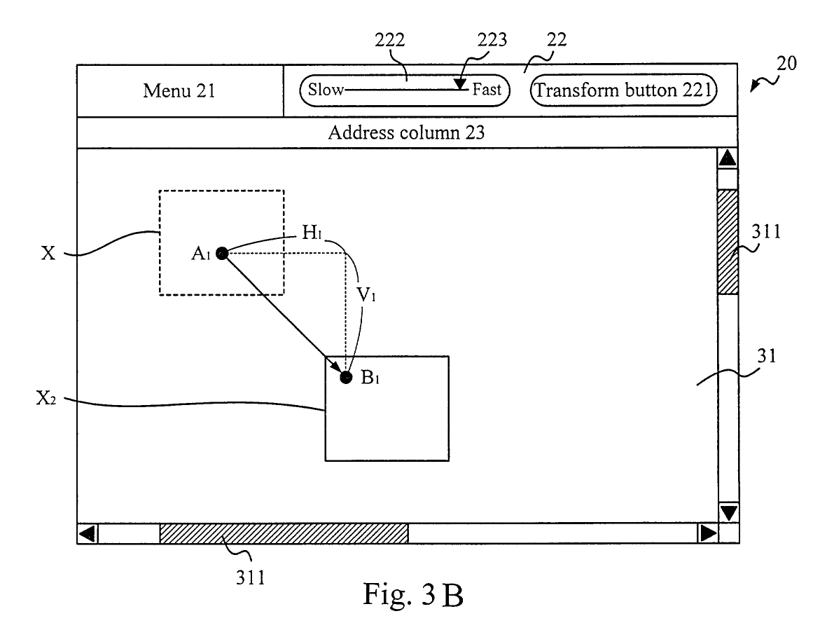

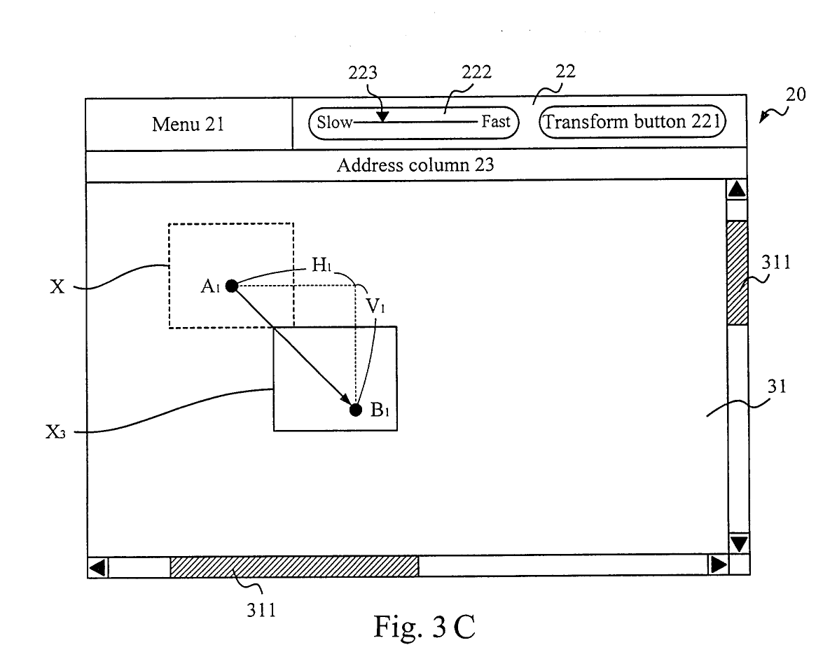

The tablet PC 10 of this embodiment is used to display a view window page 31, as shown in FIG. 3A, and the view window page 31 shows webpage content compiled by a browser 20. Since the content expanse of the view window page 31 is bigger than the displaying range of the browser 20, a view window scrollbar 311 are respectively provided at a right side and a bottom side of the view window page 31. The user may move the view window scrollbar 311 up and down, or right and left, via the input device 12 to adjust the view window page 31 (i.e., the scroll position).

In order to avoid it being too difficult for the user to utilize the input device 12 to adjust the view window scrollbar 311 (as the width of the view window scrollbar 311 may be quite narrow), the view window page 31 in this embodiment can be moved according to a movement of the input device 12 or the finger on the touch panel 11.

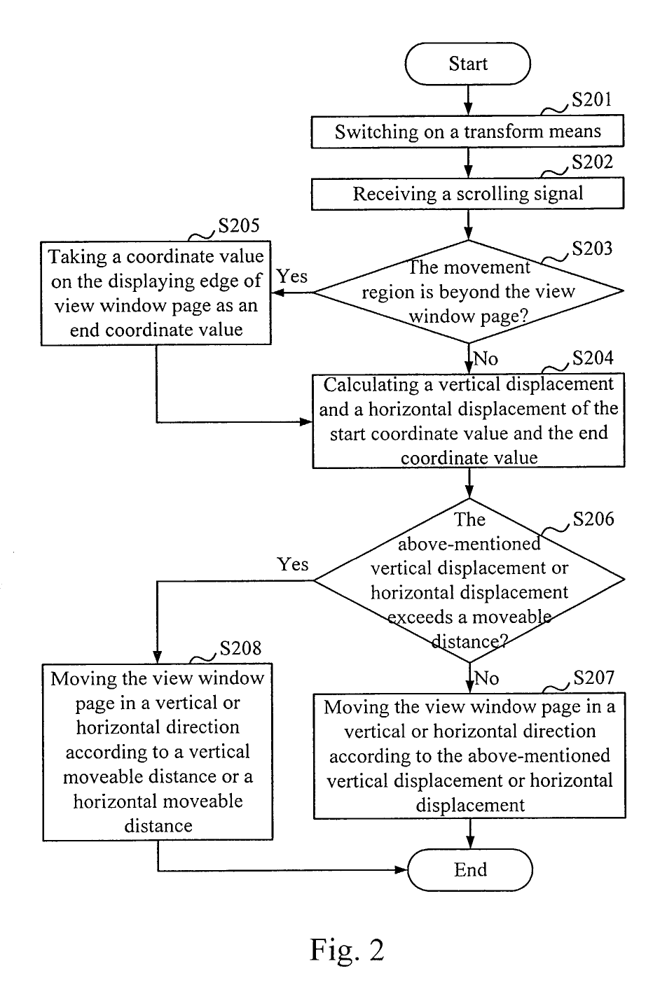

Please refer to FIG. 2. FIG. 2 is a flowchart of an embodiment of the present invention. First of all, a transform means is switched on (step S201) to transfer the tablet PC 10 from a preset browse mode to a receiving scrolling signal mode. A transform button 221 of the transform means is mounted on a tool menu 22 of the browser 20. When the input device 12 clicks the transform button 221, the tablet PC 10 transfers into the receiving scrolling signal mode, and if the input device 12 clicks the transform button 221 again, the tablet PC 10 transfers back into the preset browse mode. Moreover, while under the receiving scrolling signal mode, when the input device 12 drags on the touch panel 11, no characters or images are highlighted. But, under the preset browse mode, when the input device 12 drags on the touch panel 11, characters or images in the passed region will be highlighted for the user to edit (copy, cut, or paste) the highlighted content. The receiving scrolling signal mode does not require this highlighting function.

When the user utilizes the input device 12 to click a coordinate point A₁ and move to a coordinate point B₁, the touch panel 11, corresponding to the view window page 31, receives a scrolling signal which is generated after the movement of the input device 12 (step S202). The scrolling signal comprises a start coordinate value and an end coordinate value. It should to be noted that for the user, the input device 12 continuously moves from the coordinate point A₁ to the coordinate point B₁; but for the tablet PC 10, the continuous movement inputted by the input device 12 is sequentially divided into a plurality of scrolling signals. When the view window page 31 moves along a scrolling direction requested by the user, the path between the coordinate point A₁ and the coordinate point B₁ comprises a plurality of scrolling signals and their corresponding start coordinate values and end coordinate values.

The tablet PC 10 determines whether the movement region of the input device 12 is beyond the view window page 31 (step S203). If the movement region of the input device 12 is beyond a displaying edge of the view window page 31 displayed by the browser 20, a coordinate value on the displaying edge of view window page 31 passed by the input device 12 will be taken as an end coordinate value (step 205). Next, a vertical displacement and a horizontal displacement of the start coordinate value and the end coordinate value are calculated (step S204).

Additionally, the tablet PC 10 must determine whether the above-mentioned vertical displacement or horizontal displacement exceeds a moveable distance of the view window scrollbar 311 (step S206). If the displacement of the input device exceeds the moveable distance, and the view window page 31 has been scrolled to the end (or the top), the view window page 31 will not be scrolled further (the moveable distance is zero). Hence, the view window page 31 will be moved in a vertical or horizontal direction according to a vertical moveable distance or a horizontal moveable distance (step S208). In this embodiment, the calculated vertical displacement and horizontal displacement do not exceed the moveable distance of the view window page 31, and so the view window page 31 will move in a vertical or horizontal direction according to the above-mentioned vertical displacement or horizontal displacement (step S207).

Furthermore, a sensitivity button 223 of a sensitivity controller 222 (sensitivity transform means) in the tool menu 22 is used to adjust a moving speed and/or a distance of the view window page 31. The sensitivity button 223, as shown in FIG. 3A, indicates a normal speed. There is a total horizontal displacement H₁ and a total vertical displacement V₁ from the coordinate point A₁ to the coordinate point B₁, and the view window page 31 will move according to the total horizontal displacement H₁ and the total vertical displacement V₁. This means that the two displacements between content X before moving, and content X₁ after moving, are equal to the total horizontal displacement H₁ and the total vertical displacement V₁ from the coordinate point A₁ to the coordinate point B₁. When the sensitivity button 223 is set to a “fast” speed, as shown in FIG. 3B, the two displacements between content X before moving, and content X₂ after moving, are larger than the total horizontal displacement H₁ and the total vertical displacement V₁ from the coordinate point A₁ to the coordinate point B₁. When the sensitivity button 223 is set to a “low” speed, as shown in FIG. 3C, the two displacements between content X before moving, and content X₃ after moving, are less than the total horizontal displacement H₁ and the total vertical displacement V₁ from the coordinate point A₁ to the coordinate point B₁. In this embodiment, the sensitivity transform means in the sensitivity controller 222 of the tool menu 22 is used for adjusting the moving speed and/or a distance of the view window page 31, however the sensitivity transform means can also be set in a controller of the tablet PC 10, or be another program link.

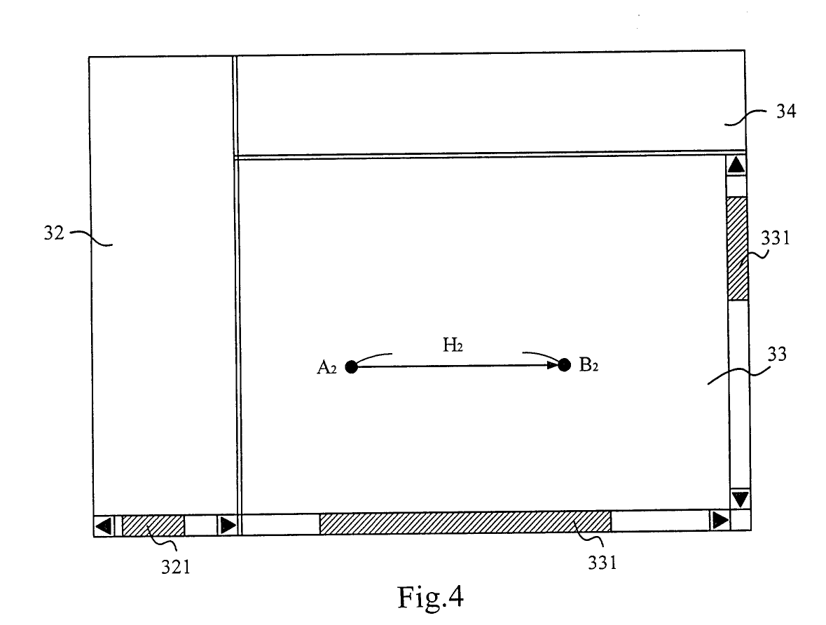

Please refer to FIG. 4. FIG. 4 is a movement schematic drawing of a view window page of a second embodiment of the present invention.

The method of the present invention can also be applied to a multiple frame webpage. For example, when the input device 12 moves from a coordinate point A₂ to a coordinate point B₂ in the view window page 33, only content displayed in the view window page 33 will be moved, and content displayed in other view window pages 32, 34 is not affected.

The above-mentioned embodiment is applied to webpage content displayed in the browser 20, but it can also be applied to content executed by other word processing software, such as Word, Excel, or other computer software that utilizes a view window scrollbar.

The method of view window scrolling of the present invention does not need a view window scrollbar to move the view window page. The present invention can move the view window page in both horizontal and vertical directions at the same time, and the user does not need to click on the narrow view window scrollbar. Therefore, the operating process of the present invention is simplified, making it easier for the user to browse document content. In addition, when the input device or the finger drags on the touch panel when scrolling, characters or images are not highlighted. The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

Although the present invention has been explained in relation to its preferred embodiment, it is to be understood that many other possible modifications and variations can be made without departing from the spirit and scope of the invention as hereinafter claimed.

What is claimed is:

1. A method of view window scrolling applied in a touch-control information apparatus, the touch-control information apparatus capable of displaying at least one view window page, and the touch-control information apparatus comprising a touch panel for inputting signals into the touch-control information apparatus via an input device or a finger of a user, the method comprising the steps of:
(A) receiving a scrolling signal generated by the inputting device or the finger moving on the touch panel corresponding to a current view window, wherein the scrolling signal stores a start coordinate value and an end coordinate value for the movement of the inputting device or the finger on the touch panel;
(B) calculating a vertical displacement and a horizontal displacement of the start coordinate value and the end coordinate value; and
(C) moving the view window in a horizontal direction according to the horizontal displacement and moving the view window in a vertical direction according to the vertical displacement.

2. The method as claimed in claim 1 further comprising a step before the step (A) of: starting a transform means to transform the touch-control information apparatus from a preset mode to a mode for receiving the scrolling signal.

3. The method as claimed in claim 2, wherein in the mode for receiving the scrolling signal, when the inputting device or the finger drags on the touch panel no characters or images are highlighted.

4. The method as claimed in claim 1, wherein when the movement of the inputting device or the finger exceeds an edge of the touch panel of the view window page, the end coordinate value is set to a corresponding coordinate value of the inputting device or the finger passing an edge of the view window page.

5. The method as claimed in claim 1, wherein in the step (C), when the horizontal displacement exceeds a moveable horizontal distance of the view window page, the view window page moves in a horizontal direction according to the moveable horizontal distance.

6. The method as claimed in claim 1, wherein in the step (C), when the vertical displacement exceeds a moveable vertical distance of the view window page, the view window page moves in a vertical direction according to the moveable vertical distance.

7. The method as claimed in claim 1, wherein the view window page further comprises a horizontal direction scrollbar or a vertical direction scrollbar, and the inputting device or the finger drags the scrollbar to move the view window page in a horizontal direction or a vertical direction.

8. The method as claimed in claim 1, wherein the touch-control information apparatus is a tablet PC.

9. The method as claimed in claim 1, wherein the inputting device is a pen.

10. The method as claimed in claim 1, wherein the view window page contains webpage content displayed by a browser.

11. The method as claimed in claim 10, wherein when a website indicated by a browser comprises a plurality of frames, webpage content of each frame is a view window page.

12. The method as claimed in claim 1, wherein the view window page contains document content displayed by word processing software.

13. A touch-control information apparatus for displaying at least one view window page, the touch-control information apparatus comprising a touch panel, the touch-control information apparatus capable of inputting a signal by a user via an input device or a finger, and containing the flowing means:
(A) means for receiving a scrolling signal generated by the inputting device or the finger moving on the touch panel corresponding to a current view window, wherein the scrolling signal stores a start coordinate value and an end coordinate value for the movement of the inputting device or the finger on the touch panel;
(B) means for calculating a vertical displacement and a horizontal displacement of the start coordinate value and the end coordinate value; and
(C) means for moving the view window in a horizontal direction according to the horizontal displacement and moving the view window in a vertical direction according to the vertical displacement.

14. The touch-control information apparatus as claimed in claim 13 further comprising a means for starting a transform means to transform the touch-control information apparatus from a preset mode to a mode for receiving the scrolling signal.

15. The touch-control information apparatus as claimed in claim 14, wherein in the mode for receiving the scrolling signal, when the inputting device or the finger drags on the touch panel no characters or images are highlighted.

16. The touch-control information apparatus as claimed in claim 13 wherein the touch-control information apparatus is a tablet PC.

17. The touch-control information apparatus as claimed in claim 13 further comprising a sensitivity transform means for adjusting a moving speed and/or distance of the view window page.
